(19) United States
(12) Patent Application Publication
(10) Pub. No.: US 2010/0021815 A1
(43) Pub. Date: Jan. 28, 2010

(54) SECONDARY BATTERIES COMPRISING EUTECTIC MIXTURE AND PREPARATION METHOD THEREOF

(75) Inventors: Jae-Seung Oh, Seoul (KR); Byoung-Bae Lee, Daejeon (KR); Ji-Won Park, Daejeon (KR); Shin-Jung Choi, Daejeon (KR); Jae-Duk Park, Daejeon (KR)

Correspondence Address: LGCHEM;Lerner, David, Littenberg, Krumholz & Mentlik, LLP, 600 South Avenue West, Westfield, NJ, 07090, US

(73) Assignee: LG Chem, Ltd., Seoul (KR)

(21) Appl. No.: 12/309,707

(22) PCT Filed: Jul. 26, 2007
(86) PCT No.: PCT/KR2007/003583

§ 371 Date: Oct. 13, 2009

(30) Foreign Application Priority Data
Jul. 28, 2006 (KR) 10-2006-0071660

(51) Int. Cl. H01M 10/26; H01M 6/04

(52) U.S. Cl. 429/207; 429/188

(57) ABSTRACT

Disclosed is a secondary battery comprising a cathode, an anode, a separator and an electrolyte, wherein the electrolyte comprises: (a) a eutectic mixture; and (b) a first compound reduced at a higher potential vs. lithium potential (Li/Li+) than the lowest limit of the electrochemical window of the eutectic mixture. The electrolyte uses a eutectic mixture in combination with an additive reduced in advance of the eutectic mixture upon the initial charge to form a solid electrolyte interface (SEI) layer. Therefore, the electrolyte can solve the problem of electrolyte decomposition occurring when using a eutectic mixture alone as an electrolyte for a battery, and thus can prevent degradation of the quality of a battery.

### TECHNICAL FIELD

The present invention relates to an electrolyte for a secondary battery, which solves the problems caused by the use of a eutectic mixture as an electrolyte while showing high thermal and chemical stability, high electric conductivity and a broad electrochemical window. The present invention also relates to a secondary battery having improved safety and quality by using the above electrolyte.

### BACKGROUND ART

Recently, interests in energy storage technology have been gradually increasing. As the use of batteries is enlarged to applications for the storage of energy for portable telephones, camcorders, notebook computers, personal computers and electric vehicles, efforts on the research and development of batteries are increasingly embodied. In this view, the field of electrochemical devices receives the greatest attention, and among them, interests in the development of chargeable/discharge able secondary batteries are focused upon.

Among secondary batteries which are now in use, lithium secondary batteries developed in the early 1990s comprise a lithium metal oxide as a cathode active material, a carbonaceous material or a lithium metal alloy as an anode active material, and a solution containing a lithium salt dissolved in an organic solvent as an electrolyte.

Organic solvents that have been used widely in recent years include ethylene carbonate, propylene carbonate, dimethoxyethane, gamma-butyrolactone (GBL), N,N-dimethyl formamide, tetrahydrofuran or acetonitrile. However, the organic solvents have enough volatility to cause evaporation, and are also highly ignitable, and thus are problematic in terms of stability under overcharge, overdischarge, short circuit and high temperature conditions, when applied to a lithium ion secondary battery.

More recently, many attempts including the use of a noninflammable ionic liquid as an electrolyte have been made mainly in Japan and USA in order to solve the above-mentioned problems. However, conventional ionic liquids are problematic in that they are expensive, are obtained via complicated synthesis and purification processes, and cause a significant drop in the capacity of a secondary battery during repeated charge/discharge cycles. Moreover, a liquid electrolyte may be leaked from an electrochemical device and is not amenable to upsizing and slimming of an electrochemical device. Therefore, to overcome such disadvantages of the conventional organic electrolytes and ionic liquids, various attempts have been made to develop a novel electrolyte containing an additive.

### DISCLOSURE OF THE INVENTION

Technical Problem

Therefore, the present invention has been made in view of the above-mentioned problems. The inventors of the present invention have conducted many studies to provide an electrolyte for a secondary battery by using a cost-efficient eutectic mixture having excellent thermal and chemical stability.

In fact, the inventors of the present invention have found that when using such a eutectic mixture is used in an electrolyte for electrochemical devices, it is possible to solve the problems of evaporation, exhaust and ignition of electrolytes caused when using a conventional organic solvent as an electrolyte. We have also found that it is possible to improve the quality of a battery by virtue of excellent conductivity, a broad electrochemical window and low viscosity of the eutectic mixture.

However, we have recognized that when an electrolyte containing a eutectic mixture is used in combination with a conventional carbonaceous material-based anode, the electrolyte is decomposed due to electrochemical reactions generated at a potential beyond the chemical window of the eutectic mixture, resulting in degradation of the quality of a battery.

Therefore, it is an object of the present invention to provide a secondary battery which uses a eutectic mixture in combination with an additive for preventing the decomposition of the eutectic mixture to form an electrolyte, and thus shows improved safety and quality.

Technical Solution

According to an aspect of the present invention, there is provided a secondary battery comprising a cathode, an anode, a separator and an electrolyte, wherein the electrolyte comprises: (a) a eutectic mixture; and (b) a first compound reduced at a higher potential vs. lithium potential (Li/Li⁺) than the lowest limit of the electrochemical window of the eutectic mixture. There is also provided the same electrolyte.

According to another aspect of the present invention, there is provided a secondary battery comprising a cathode, an anode, a separator and an electrolyte, wherein the electrolyte comprises a eutectic mixture formed of an amide group-containing compound and an ionizable lithium salt, and the anode is an electrode preliminarily coated with a coating layer partially or totally formed on a surface thereof, the coating layer comprising a first compound reduced at a higher potential vs. lithium potential (Li/Li⁺) than the eutectic mixture or a reduced product thereof.

The present invention is characterized by using a eutectic mixture in combination with an additive having a potential vs. lithium potential (Li/Li⁺) in a region beyond the electrochemical window of the eutectic mixture to form an electrolyte for a battery.

As generally known in the art, like an ionic liquid (IL), a eutectic mixture has high electric conductivity, a broad electrochemical window, non-flammability, a broad range of temperatures where it exists as a liquid, a high solvation capability and a non-coordinate bonding capability, and thus shows physicochemical properties as an eco-friendly solvent that can substitute for existing harmful organic solvents. Moreover, since a eutectic mixture is prepared more easily as compared to an ionic liquid and has flame resistance, a high ionic concentration and a broad electrochemical window (0.5˜5.5V), it can be expected that a eutectic mixture has a broad spectrum of applications. However, when an electrolyte using such an eutectic mixture alone is used in combination with a carbonaceous material as an anode active material to form a secondary battery, decomposition of an electrolyte and degradation of the quality of the secondary battery occur due to electrochemical reactions of an anode generated at a potential (e.g. 0˜1V) beyond the electrochemical window of the eutectic mixture.

In other words, when an electrochemical reaction occurs under a potential beyond the electrochemical window of an electrolyte at either of the cathode or the anode of a battery during charge/discharge cycles of the battery, electrolyte decomposition occurs. For example, when a carbonaceous material having a potential vs. lithium potential of 0˜1V is used as an anode active material in combination with a eutectic mixture having an, electrochemical window of 1V or more as an electrolyte, reduction occurs at the anode due to the potential beyond the electrochemical window, thereby causing decomposition of the eutectic mixture, resulting in a rapid drop in the initial capacity and lifespan of a battery.

In this regard, the inventors of the present invention have recognized that there is an interrelation between decomposition of a eutectic mixture during the initial charge and the problem of a drop in the initial capacity and lifespan of a battery. Thus, according to the present invention, it is possible to solve the problems of decomposition of an electrolyte and degradation of the quality of a battery by using an additive for an electrolyte that can cover a range of potentials beyond the electrochemical window of the eutectic mixture, and can be reduced in advance of the other components upon the first charge to form a firm and highly stable solid electrolyte interface (SEI) layer with ease.

Hereinafter, the present invention will be explained in more detail.

<Electrolyte Comprising Eutectic Mixture and First Compound>

One constitutional element for forming the electrolyte for a battery according to the present invention is a compound (also referred to as ‘first compound’ hereinafter) that can cover a range of potentials beyond the electrochemical window of the eutectic mixture, and can be reduced in advance of the other components upon the first charge to form an SEI layer with ease.

The first compound (b) has a higher reduction potential (vs. Li/Li⁺) than the eutectic mixture, and suitably has a higher reduction potential vs. lithium potential than the lowest limit of the electrochemical window of the eutectic mixture. For example, the first compound may have a reduction potential (vs. Li/Li⁺) of 0˜2 V.

The first compound is reduced and decomposed upon the first charge of the battery to form a solid electrolyte interface (SEI) layer. The resultant SEI layer can prevent side reactions between an anode active material and an electrolyte solvent, and also a structural collapse of an anode active material caused by the co-intercalation of the electrolyte solvent into the anode active material. Additionally, the SEI layer serves satisfactorily as a tunnel for transferring lithium ions so as to minimize degradation of the quality of the battery. Further, the SEI layer can prevent the decomposition of the eutectic mixture and degradation of the quality of the battery caused thereby.

Non-limiting examples of the first compound that may be used in the present invention include 12-crown-4,18-crown-6, catechol carbonate, vinylene carbonate, ethylene sulfite, methyl chloroformate, succinimide, methyl cinnamate or a mixture thereof.

The first compound may be used in an amount controlled in a range currently used in the art in consideration of the quality of the battery. For example, the first compound may be used in an amount of 0.01˜10 parts by weight based on 100 parts by weight of the electrolyte.

The other constitutional element forming the electrolyte for the battery according to the present invention includes the eutectic mixture (a).

Generally, a eutectic mixture is referred to as a mixture containing two or more substances and having a decreased melting point. Particularly, such eutectic mixtures include mixed salts present in a liquid phase at room temperature. Herein, room temperature means a temperature of up to 100° C. or a temperature of up to 60° C. in some cases.

According to a preferred embodiment of the present invention, one of the constitutional elements forming the eutectic mixture is an amide group-containing compound having two different polar functional groups, i.e. a carbonyl group and an amine group, in its molecule. However, any compound having at least two polar functional groups (e.g. an acidic group and a basic group) in the molecule may be used with no particular limitation. The polar functional groups different from each other serve as complexing agents that weaken the bond between the cation and the anion of the ionizable salt, thereby forming a eutectic mixture, resulting in a drop in the melting temperature. In addition to the above functional groups, compounds comprising polar functional groups that can weaken the bond between a cation and anion of an ionizable salt, and thus are capable of forming a eutectic mixture, are also included in the scope of the present invention.

The amide group-containing compound may be an amide group-containing compound having a linear structure, a cyclic structure or a combination thereof. Non-limiting examples of the amine group-containing compound include C1˜C10 alkyl amide, alkenyl amide, aryl amide or allyl amide compounds. Also, primary, secondary or tertiary amide compounds may be used. It is more preferable to use a cyclic amide compound showing a broader electrochemical window because such cyclic amide compounds have a smaller number of hydrogen atoms and are stable under a high voltage so as to prevent decomposition thereof. Non-limiting examples of the amide compound that may be used in the present invention include acetamide, urea, methyl urea, caprolactam, valerlactam, carbamate, trifluoroacetamide, methyl carbamate, formamide, formate, and mixtures thereof.

The other constitutional element forming the eutectic mixture according to the present invention includes any lithium-containing ionizable salts. Non-limiting examples of such salts include lithium nitrate, lithium acetate, lithium hydroxide, lithium sulfate, lithium alkoxide, lithium halides, lithium oxide, lithium carbonate, lithium oxalate, or the like. Particularly, LiN(CN)₂, LiClO₄, Li(CF₃)₃PF₃, Li(CF₃)₄PF₂, Li(CF₃)₅PF, Li(CF₃)₆P, Li(CF₂CF₂SO₂)₂N, Li(CF₃SO₂)₂N, LiCF₃SO₃, LiCF₃CF₂(CF₃)₂CO, Li(CF₃SO₂)₃C, Li(CF₃SO₂)₃C, LiCF₃(CF₂)₇SO₃, LiCF₃CO₂, LiCH₃CO₂, and mixtures thereof are preferred.

The eutectic mixture according to the present invention may be represented by the following Formula 1 or Formula 2, but is not limited thereto:

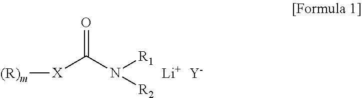

wherein each of R₁, R₂ and R independently represents a hydrogen atom, halogen atom, C1˜C20 alkyl group, alkylamine group, alkenyl group or an aryl group;

X is selected from the group consisting of hydrogen, carbon, silicon, oxygen, nitrogen, phosphor and sulfur, with the proviso that where X is hydrogen, m=0, where X is oxygen or sulfur, m=1, where X is nitrogen or phosphor, m=2, and where X is carbon or silicon, m=3, each R being independent from the others; and

Y is an anion capable of forming a salt with lithium.

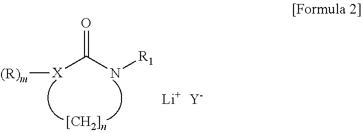

wherein each of R₁ and R independently represents a hydrogen atom, C1˜C20 alkyl group, alkylamine group, alkenyl group, aryl group or an allyl group;

X is selected from the group consisting of hydrogen, carbon, silicon, oxygen, nitrogen, phosphor and sulfur, with the proviso that where X is hydrogen, m=0 and n=0, where X is oxygen or sulfur, m=0, where X is nitrogen or phosphor, m=1, and where X is carbon or silicon, m=2, each R being independent from the others;

n is an integer of 0˜10, with the proviso that where n is equal to or greater than 1, X is selected from carbon, silicon, oxygen, nitrogen, phosphor and sulfur, except hydrogen; and

Y is an anion capable of forming a salt with lithium.

In the compound represented by the above Formula 1 or Formula 2, there is no particular limitation on anion Y of the lithium salt as long as it is capable of forming a salt with lithium. Non-limiting examples of such anions include: F⁻, Cl⁻, Br⁻, I⁻, NO₃⁻, N(CN)₂⁻, BF₄⁻, ClO₄⁻, PF₆⁻, (CF₃)₂PF₄⁻, (CF₃)₃PF₃⁻, (CF₃)₄PF₂⁻, (CF₃)₅PF⁻, (CF₃)₆P⁻, CF₃SO₃⁻, CF₃CF₂SO₃⁻, (CF₃SO₂)₂N⁻, (FSO₂)₂N⁻, CF₃CF₂(CF₃)₂CO⁻, (CF₃SO₂)₂CH⁻, (SF₅)₃C⁻, (CF₃SO₂)₃C⁻, CF₃(CF₂)₇SO₃⁻, CF₃CO₂⁻, CH₃CO₂⁻, SCN⁻, (CF₃CF₂SO₂)₂N⁻, etc.

As described above, the constitutional elements of the eutectic mixture, i.e. the amide group-containing compound and the lithium salt (LiY) cause the formation of a coordination bond between the carbonyl group (C═O) present in the amide group-containing compound and the lithium cation (Li⁺) of the lithium salt, as well as the formation of a hydrogen bond between the anion (Y⁻) of the lithium salt and the amine group (—NH₂) present in the amide group-containing compound, as shown in the following Reaction Scheme 1. As a result, the amide group-containing compound and the lithium salt, which were originally present in a solid state, show a decreased melting point, while they form a eutectic mixture present in a liquid state at room temperature.

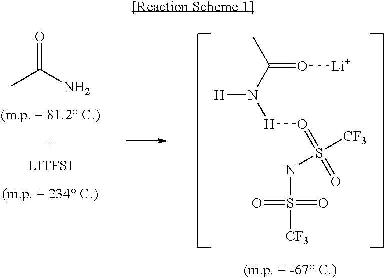

Although there is no particular limitation on the melting point of the eutectic mixture according to the present invention, it is preferable that the eutectic mixture is in a liquid state at a temperature of up to 100° C., and more preferably at room temperature. Also, although there is no particular limitation on viscosity of the eutectic mixture according to the present invention, the eutectic mixture preferably has a viscosity of 100 cp or less.

The eutectic mixture may be prepared by a conventional process known to one skilled in the art. For example, a compound having an amide group is mixed with a lithium salt at room temperature and then the mixture is allowed to react by heating it at a suitable temperature of 70° C. or less, followed by purification. Herein, the molar ratio (%) of the amide-based compound to the lithium salt suitably ranges from 1:1 to 8:1, and more preferably from 2:1 to 6:1.

The electrolyte comprising the aforementioned eutectic mixture provides the following advantages:

(1) The electrolyte comprising the aforementioned eutectic mixture shows a broader electrochemical window when compared to conventional organic solvents and ionic liquids due to the basic physical properties of the eutectic mixture, including physical stability of the eutectic mixture itself, so that an electrochemical device using the above electrolyte can have an extended range of drive voltage. In fact, conventional electrolytes using ionic liquids and organic solvents show an upper limit of the electrochemical window of approximately 4˜4.5V, while the eutectic mixture according to the present invention shows an upper limit of the electrochemical window of 4.5˜5.7V, which is significantly extended when compared to the conventional electrolytes based on ionic liquids and organic solvents. More particularly, the eutectic mixtures of caprolactam/LiTFSI and valerolactam/LiTFSI have an electrochemical window of 5.5V, and the eutectic mixture of LiSO₃CF₃/methyl urea shows an electrochemical window of 5.7V. Thus, the eutectic mixtures can be applied to a high drive voltage (see Table 1).

Additionally, the eutectic mixture contained in the electrolyte according to the present invention has no vapor pressure contrary to conventional solvents, and thus shows no problem of evaporation and exhaustion of the electrolyte. Also, the eutectic mixture has flame resistance, thereby improving the safety of an electrochemical device. Moreover, the eutectic mixture itself is very stable, and thus can inhibit side reactions in the electrochemical device. Further, high conductivity of the eutectic mixture can contribute to improvement of the quality of a battery.

(2) Additionally, since the eutectic mixture contains a lithium salt, the addition of a separate lithium salt can be avoided even in the case of a lithium secondary battery requiring intercalation/deintercalation of lithium ions into/from a cathode active material.

(3) Further, the eutectic mixture contains lithium ions (Li⁺) only as cations, as compared to ionic liquids containing two types of cations. Thus, it is possible to solve the problem caused by such cations competing with each other and inhibiting lithium ion intercalation into an anode, and thus to facilitate smooth lithium ion conduction.

The electrolyte according to the present invention may further comprise conventional additives in addition to the aforementioned components. For examples, the electrolyte according to the present invention may further comprise a compound (also referred to as ‘a second compound’ hereinafter) having a higher oxidation potential vs. lithium potential (Li/Li⁺) than the cathode potential.

The second compound may be oxidized at a higher voltage than the normal drive voltage of the cathode (e.g. 4.2V), and consumes an overcharged current upon the oxidation via gas generation, formation of a passivation layer and a reversible redox shuttle to improve the safety of the battery. Non-limiting examples of the second compound include iodine, ferrocene-based compounds, triazolium salts, tricyanobenzene, tetracyanoquinodimethane, benzene-based compounds, pyrocarbonates, cyclohexylbenzene (CHB) or a mixture thereof.

The eutectic mixture according to the present invention may be applied to any electrolytes regardless of the forms of electrolytes. Preferably, the eutectic mixture may be applied to two types of electrolytes, i.e. liquid electrolytes and gel polymer electrolytes.

(1) The liquid electrolyte according to the present invention may be obtained by combining the eutectic mixture (a) with the first compound reduced at a higher potential vs. lithium potential (Li/Li⁺) than the eutectic mixture.

(2) The gel polymer electrolyte according to the present invention may be obtained by carrying out polymerization of monomers in the presence of the eutectic mixture (a) and the first compound (b), or by impregnating a conventional polymer or gel polymer with the eutectic mixture and the first compound.

First, the gel polymer electrolyte obtained via polymerization will be explained.

The gel polymer electrolyte according to the present invention may be formed by carrying out polymerization of an electrolyte precursor solution containing: (a) the eutectic mixture; (b) the first compound reduced at a higher potential vs. lithium potential (Li/Li⁺) than the eutectic mixture; and (c) monomers capable of forming a gel polymer via polymerization.

There is no limitation on the kind of monomer as long as it is capable of forming a gel polymer by polymerization, and particular examples of such monomers include vinyl monomers, etc. Vinyl monomers have advantages in that they can provide transparent polymerization products when mixed with a eutectic mixture and are amenable to simple polymerization conditions.

Non-limiting examples of the vinyl monomer that may be used according to the present invention include acrylonitrile, methyl methacrylate, methyl acrylate, methacrylonitrile, methyl styrene, vinyl esters, vinyl chloride, vinylidene chloride, acrylamide, tetrafluoroethylene, vinyl acetate, methyl vinyl ketone, ethylene, styrene, para-methoxystyrene, para-cyanostyrene, etc. Preferably, the monomer capable of forming a gel polymer by polymerization provides low volumetric shrinkage upon polymerization and permits in-situ polymerization inside of an electrochemical device.

The polymerization of the monomers is generally performed under heat or UV irradiation, and thus the electrolyte pre-gel may further comprise a polymerization initiator or a photoinitiator.

The precursor solution of gel polymer electrolyte according to the present invention further comprises initiators known to one skilled in the art.

Initiators are decomposed by heat or UV rays to form radicals, and then react with a monomer through free radical polymerization to form a gel polymer electrolyte. It is also possible to carry out polymerization of monomers without using any initiator. Generally, free radical polymerization includes an initiation step in which transient molecules or active points having strong reactivity are formed; a propagation step in which a monomer is added to the end of an active chain to form another active point at the end of the chain; a chain transfer step in which active points are transferred to other molecules; and a termination step in which the center of an active chain is broken.

Thermal initiators that may be used in the polymerization include organic peroxides or hydroperoxides such as benzoyl peroxide, acetyl peroxide, dilauryl peroxide, di-tert-butyl peroxide, cumyl hydroperoxide, hydrogen peroxide, etc., and azo compounds such as 2,2-azobis(2-cyanobutane), 2,2-azobis(methylbutyronitrile), AIBN(azobis(isobutyronitrile), AMVN (azobisdimethyl-valeronitrile), organometallic compounds such as alkylated silver compounds, etc.

In addition to the above-described materials, the precursor solution of the gel polymer electrolyte according to the present invention optionally further comprises other additives known to one skilled in the art.

The gel polymer electrolyte may be prepared with the precursor solution of gel polymer electrolyte by using a method generally known to those skilled in the art. The method may be performed according to the following three types of embodiments.

\textcircled{1} First, the gel polymer electrolyte may be obtained via in-situ polymerization inside a battery. Herein, the in-situ polymerization may be performed by heating or irradiating UV rays. Additionally, in the case of thermal polymerization, formation of a gel polymer electrolyte depends on the polymerization time and the polymerization temperature. In the case of UV polymerization, formation of a gel polymer electrolyte depends on the irradiation dose. The polymerization time generally ranges from 20 minutes to 60 minutes, and the polymerization temperature ranges from 40° C. to 80° C.

Further, the composition of the electrolyte precursor solution for forming the gel polymer electrolyte according to the present invention may be suitably controlled considering the quality and safety of the battery. There is no particular limitation in the composition of the electrolyte precursor solution.

As described above, initiation of the thermal or UV polymerization results in the formation of the gel polymer electrolyte. Herein, the polymerization degree of the gel polymer may be controlled depending on the reaction factors, including the polymerization time, polymerization temperature or irradiation dose. The polymerization time varies with the kind of the initiator used for the polymerization and the polymerization temperature. Preferably, the polymerization time is sufficient to prevent the gel polymer electrolyte from leaking during the polymerization. Also, the polymerization should be performed for a period of time sufficient to prevent over-polymerization and shrinking of the electrolyte.

\textcircled{2} According to another preferred embodiment of the gel polymer electrolyte comprising the eutectic mixture according to the present invention may be obtained not by the aforementioned in-situ polymerization but by injecting the eutectic mixture (a) and the first compound (b) to a preliminarily formed polymer or gel polymer so that the polymer or gel polymer is impregnated with the eutectic mixture and the first compound.

Non-limiting examples of the polymer that may be used in the present invention include polymethyl methacrylate, polyvinylidene difluoride, polyvinyl chloride, polyethylene oxide, polyhydroxyethyl methacrylate, etc. Any gel polymers known to one skilled in the art may also be used. In this case, it is possible to simplify processing steps compared to the above in-situ polymerization method.

\textcircled{3} According to still another preferred embodiment of the present invention, a polymer, the eutectic mixture (a) and the first compound (b) are dissolved in a solvent, and then the solvent is removed to form a gel polymer electrolyte. Herein, the eutectic mixture is included in the polymer matrix.

Although there is no particular limitation on selecting the solvent, and an organic solvent currently used in a battery may be used. Non-limiting examples of the solvent include toluene, acetone, acetonitrile, THF, propylene carbonate (PC), ethylene carbonate (EC), diethyl carbonate (DEC), dimethyl carbonate (DMC), dipropyl carbonate (DPC), dimethyl sulfoxide, acetonitrile, dimethoxyethane, diethoxyethane, tetrahydrofuran, N-methyl-2-pyrrolidone (NMP), ethyl methyl carbonate (EMC), gamma-butyrolactone (GBL) or a mixture thereof. Such organic solvents may deteriorate the safety of a secondary battery due to their inflammability. Thus, it is preferable to use such organic solvents in a small amount. Additionally, phosphates may be used as a flame retardant currently used for a lithium secondary battery, and non-limiting examples thereof include trimethyl phosphate, triethyl phosphate, ethyl dimethyl phosphate, tripropyl phosphate, tributyl phosphate, tributyl phosphate or a mixture thereof.

Additionally, there is no particular limitation on the method for removing the solvent and any conventional heating methods may be used. The third method has a disadvantage in that there is a need of a post-treatment step for removing a solvent in order to form the gel polymer electrolyte.

<Secondary Battery Using Electrolyte Comprising Eutectic Mixture and First Compound>

The secondary battery according to the present invention comprises an anode, a cathode, an electrolyte and a separator, as shown in FIG. 1.

Herein, the secondary battery includes all types of secondary batteries in which electrochemical reactions are performed continuously through repeated charge/discharge cycles. Preferably, the secondary batteries are lithium secondary batteries and non-limiting examples of the lithium secondary battery include lithium metal secondary batteries, lithium ion secondary batteries, lithium polymer secondary batteries or lithium ion polymer batteries.

The secondary battery may be manufactured by using a method generally known to those skilled in the art. According to one embodiment of the method, both electrodes (a cathode and an anode) are stacked with a separator interposed between both electrodes to form an electrode assembly, and then the electrolyte containing the eutectic mixture and the first compound is injected thereto.

The cathode and the anode may be obtained by a conventional method known to those skilled in the art. Particularly, electrode slurry containing each electrode active material, i.e. a cathode active material or an anode active material, is provided, the electrode slurry is applied onto each current collector, and the solvent or dispersant is removed.

Anode active materials may include any conventional anode active materials currently used in an anode of a conventional secondary battery. Non-limiting examples of the anode active material that may be used in the present invention include WO₃, MoO₃, LiCr₃O₈, LiV₃O₈, TiS₂, oxides represented by the formula of LiₓTi_{5/3-y}L_{y}O₄, such as Li_{4/3}Ti_{5/3}O₅ having a spinel type structure, a mixture thereof, or the like.

In the above oxide (LiₓTi_{5/3-y}L_{y}O₄), L represents at least one element selected from the group consisting of Group 2 to Group 16 elements, except Ti and O, and non-limiting examples of substituent element L include Be, B, C, Mg, Al, Si, P, Ca, Sc, V, Cr, Mn, Fe, Co, Ni, Cu, Zn, Ga, Ge, As, Se, S, Y, Zr, Nb, Mo, Pd, Ag, Cd, In, Sn, Sb, Te, Ba, La, Ta, W, Hg, Au, Pb or a combination thereof. Additionally, x and y are preferably 4/3≦x≦7/3 and 0≦y≦5/3, but are not limited thereto.

Particularly, according to the present invention, it is possible to prevent the decomposition of the electrolyte caused by the electrochemical reactions occurring at the anode in a range of potentials beyond the electrochemical window of the eutectic mixture. Thus, it is possible to use any anode active material whose reduction potential vs. lithium potential (Li/Li⁺) is beyond the electrochemical window of the eutectic mixture (e.g. a carbonaceous material and/or metal oxide having a reduction potential vs. lithium potential (Li/Li⁺) is lower than 1V) with no particular limitation. Therefore, the present invention can provide secondary batteries having a high discharge capacity and improved lifespan and safety by using anodes comprising various carbonaceous materials.

Different carbonaceous materials have different characteristics as described hereinafter.

Graphitic carbon allows a constant discharge voltage and serves to maintain high capacity during repeated charge/discharge cycles. Non-graphitic carbon reduces a drop in the capacity during repeated charge/discharge cycles, and thus increases the charge/discharge efficiency. Additionally, hard carbon allows high initial capacity and serves to compensate for a drop in the initial capacity caused by the use of non-graphitic carbon. Therefore, such carbonaceous materials may be used in combination with each other depending on the desired quality of a finally formed battery to maximize the effects of the carbonaceous materials.

Anode active materials may include any conventional anode active materials currently used in an anode of a conventional secondary battery.

The cathode active material that may be used in the present invention includes conventional cathode active materials currently used in the art. For example, metals or metal oxides with a potential vs. lithium (Li/Li⁺) of 4V or more may be used with no particular limitation. Non-limiting examples of the cathode active material include LiCoO₂, LiNiO₂, LiMnO₂, LiMn₂O₄, LiCrO₂, LiFePO₄, LiFeO₂, LiCoVO₄, LiCrₓMn₂₋ₓO₄(0<x<2), LiNiVO₄, LiNiₓMn₂₋ₓO₄ (0<x<2), Li₂₋ₓCoMn₃O₈ (0<x<2), oxides represented by the formula of Liₓ [Ni_{2-y}M_{y}O₄] (0<x<1, 0<y<2) having a spinel type structure, or the like.

In the above oxides (LiₓNi_{2-y}M_{y}O₄]), M represents at least one transition metal generally known to those skilled in the art, other than nickel, and non-limiting examples thereof include Mn, Co, Zn, Fe, V or a combination thereof. Additionally, x and y are preferably 0<x<1, 0<y<2, but are not limited thereto.

The separator that may be used in the present invention includes a porous separator that serves to interrupt an internal short circuit between both electrodes and is impregnated with an electrolyte. Non-limiting examples of the separator include a polypropylene-based, polyethylene-based or polyolefin-based separator, or a composite porous separator comprising inorganic materials incorporated into the porous separator.

In addition to the above constitutional elements, the secondary battery may further comprise conductive elastic polymers for filling the remaining space of the secondary battery.

According to a preferred embodiment of the present invention, the eutectic mixture has a lower limit of its electrochemical window of 0.5˜2V (vs. Li/Li⁺), the anode has a reduction potential vs. lithium potential ranging from 0 to the lower limit of the electrochemical window of the eutectic mixture, and the first compound has a higher potential (vs. Li/Li⁺) than the lower limit of the electrochemical window of the eutectic mixture and is reduced upon the initial charge to form a solid electrolyte interface (SEI) layer.

Further, the present invention provides a secondary battery comprising a cathode, an anode, a separator and an electrolyte, wherein the electrolyte comprises a eutectic mixture comprising an amide group-containing compound and an ionizable lithium salt, and the anode is preliminarily coated with a coating layer partially or totally formed on a surface thereof, the coating layer comprising a first compound reduced at a higher potential (vs. Li/Li⁺) than the eutectic mixture or a reduced product thereof.

When the anode is subjected to charge/discharge cycles in the presence of the electrolyte comprising the eutectic mixture and the first compound, the first compound in the electrolyte may be formed on the surface of the electrode active material together with reversible lithium ions. In a variant, the first compound may be coated on the surface of the electrode active material before assembling the battery, or may be used in combination with materials forming the electrode. In another variant, the first compound may be coated on the surface of a preliminarily formed electrode.

The first compound is the same as defined above. The electrode may be coated and manufactured according to conventional methods.

There is no particular limitation on the outer shape of the lithium secondary battery obtained in the above-described manner. The lithium secondary battery may be a cylindrical battery using a can, a prismatic battery, or a pouch-type battery.

### BRIEF DESCRIPTION OF THE DRAWINGS

The foregoing and other objects, features and advantages of the present invention will become more apparent from the following detailed description when taken in conjunction with the accompanying drawings in which:

FIG. 1 is a schematic sectional view showing a coin type secondary battery;

FIG. 2 is a graph showing variations in the capacity of the lithium secondary battery using a first compound and a eutectic mixture-containing as an electrolyte according to Example 1; and

FIG. 3 is a graph showing variations in the capacity of the lithium secondary battery using a eutectic mixture as an electrolyte according to Comparative Example 2.

### BEST MODE FOR CARRYING OUT THE INVENTION

Reference will now be made in detail to the preferred embodiments of the present invention. It is to be understood that the following examples are illustrative only and the present invention is not limited thereto.

### Examples 1˜11

### Example 1

First, 5 g of purified methyl carbamate and 6 g of Li(CF₃SO₂)₂N were introduced into a round bottom flask, and agitated gradually at room temperature under nitrogen atmosphere for 12 hours to obtain 11 g of a eutectic mixture. The eutectic mixture was dried to a water content of 20 ppm or less under a vacuum of 0.3 torr. The eutectic mixture showed physical properties as described in the following Table 1. To the eutectic mixture, 5 wt % of vinylene carbonate (2V. vs. Li potential) was added to provide an electrolyte.

Graphite as an anode active material, artificial graphite and a binder were mixed in a weight ratio of 94:3:3, and N-methylpyrrolidone was added to the resultant mixture to provide slurry. The slurry was applied onto copper foil, and then dried at 130° C. for 2 hours to provide an anode.

LiCoO₂ as a cathode active material, artificial graphite as a conductive agent and polyvinylidene fluoride as a binder were mixed in a weight ratio of 94:3:3, and N-methylpyrrolidone was added to the resultant mixture to provide slurry. The slurry was applied onto aluminum foil, and then dried at 130° C. for 2 hours to provide a cathode.

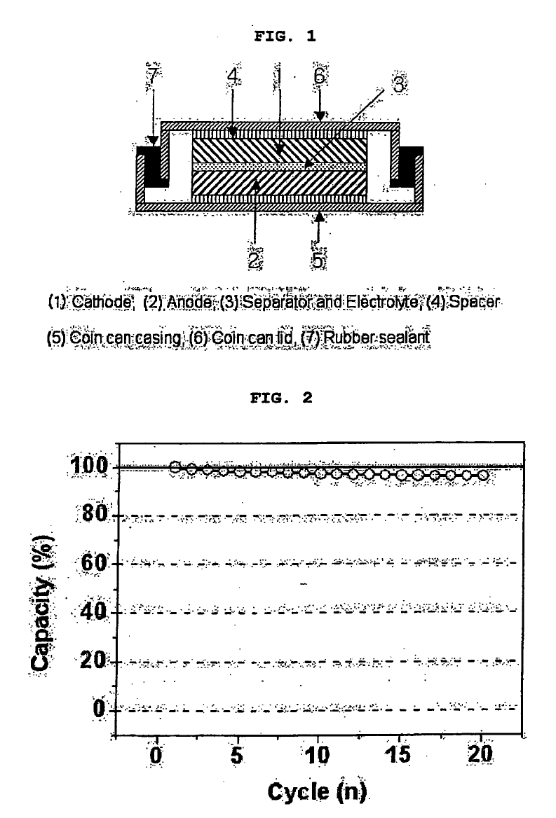

The cathode and the anode obtained as described above were provided, each in a size of 1 cm², and a separator was inserted between both electrodes, and the electrolyte obtained as described above was injected thereto to provide a secondary battery as shown in FIG. 1.

### Examples 2˜11

Lithium secondary batteries were provided in the same manner as described in Example 1, except that the amide group-containing compounds and the lithium salts as shown in the following Table 1 were used instead of purified methyl carbamate and Li(CF₃SO₂)₂N.

After the batteries were subjected to a charge/discharge test, it could be seen that the batteries had excellent energy density and were safe against overcharge, overdischarge, generation of a short and thermal impact.

### Comparative Example 1

A lithium secondary battery was provided in the same manner as described in Example 1, except that the ionic liquid (EMI-BF₄) was used alone as an electrolyte while not adding vinylene carbonate thereto.

### Comparative Example 2

A lithium secondary battery was provided in the same manner as described in Example 1, except that the eutectic mixture was used alone as an electrolyte while not adding vinylene carbonate thereto.

### Experimental Example 1

### Evaluation of Physical Properties for Eutectic Mixtures

The following test was performed to evaluate physical properties of the eutectic mixture comprising an amide group-containing compound and a lithium salt according to the present invention.

Each eutectic mixture was measured for its melting point by using DSC (differential scanning calorimeter). Also, the viscosity and the electric conductivity of each eutectic mixture were measured. Further, each eutectic mixture was measured for its electrochemical window by using glassy carbon as a working electrode, lithium as a reference electrode, and lithium or platinum as a counter electrode. The results are shown in the following Table 1.

TABLE 1

| | | | Mol. | Tm | μ | k | Electrochem. |
|---|---|---|---|---|---|---|---|
| No. | Salt | Amide | ratio | (° C.) | (cP) | (mS/cm) | Window (V) |
| 1 | LiTFSI | Methylcarbamate | 1:3 | −65.0 | 23.5 | 1.43 | 0.5~5.5 |
| 2 | LiTFSI | Acetamide | 1:4 | −67.0 | 100 | 1.07 | 0.7~5.3 |
| 3 | LiTFSI | N- | 1:3 | −51.7 | 79.5 | 0.30 | 1.2~5.3 |
| | | benzylformamide | | | | | |
| 4 | LiTFSI | Trifluoroacetamide | 1:3 | −10.7 | 89 | 0.83 | 0.9~5.8 |
| 5 | LiTFSI | Methylurea | 1:3 | −8.2 | 677 | 0.12 | 0.5~5.3 |
| 6 | LiTFSI | Valerolactam | 1:3 | −44.8 | 910 | 0.17 | 0.5~5.5 |
| 7 | LiTFSI | Caprolactam | 1:3 | −38.3 | 3100 | 0.03 | 0.3~5.5 |
| 8 | LiClO₄ | Methylurea | 1:3 | −9.2 | 990 | 0.22 | 1.3~5.3 |
| 9 | LiSO₃CF₃ | Acetamide | 1:4 | −50.3 | 30.4 | 3.47 | 0.8~5.5 |
| 10 | LiSO₃CF₃ | Methylurea | 1:3 | −34.4 | 85.8 | 2.50 | 0.7~5.7 |
| 11 | LiSO₃CF₃ | Valerolactam | 1:3 | −48.0 | 285 | 0.46 | 0.8~5.2 |

### Experimental Example 2

### Analysis for Characteristics of Secondary Battery

The lithium secondary battery comprising a eutectic mixture as an electrolyte was analyzed for its characteristics according to the following test. The lithium secondary battery using an electrolyte containing the eutectic mixture and the first compound was used as a sample. As controls, the lithium secondary battery using an ionic liquid-containing electrolyte (EMI-BF₄) according to Comparative Example 1, and the lithium secondary battery using the eutectic mixture as an electrolyte according to Comparative Example 2 were used.

After the test, the secondary battery according to Example 1 showed a discharge capacity of about 99% and a charge/discharge efficiency of about 99% (see FIG. 2). Since the anode and the cathode have a drive voltage of about 0.5V and about 4.2V, respectively, vs. lithium potential, and the eutectic mixture has an electrochemical window of 0.5V˜5.5V, the secondary battery comprising the above elements shows a drive voltage of about 3.7V, provides excellent energy density, and is stable against overcharge, overdischarge, a short circuit and thermal impact.

On the other hand, the secondary battery using the ionic liquid (EMI-BF₄) as an electrolyte showed a discharge capacity of about 80%, and a charge/discharge efficiency of 70% or less (see FIG. 2).

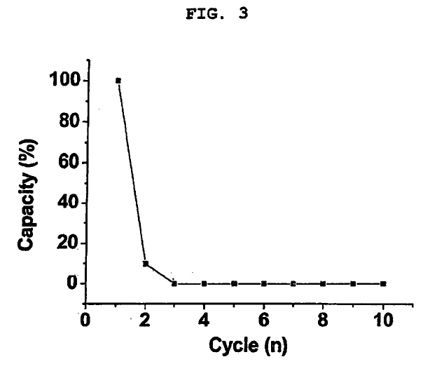

Particularly, the lithium secondary battery using the eutectic mixture alone as an electrolyte according to Comparative Example 2 showed a rapid drop in the capacity from the second cycle (see FIG. 3). This demonstrates that the carbonaceous material used as the anode active material causes electrochemical reactions in a range of potentials beyond the electrochemical window of the eutectic mixture contained in the electrolyte, resulting in degradation of the quality of the battery.

Therefore, it can be seen from the above experimental results that the lithium secondary battery using the electrolyte comprising the eutectic mixture and the additive compound reduced at a higher potential (vs. Li/Li⁺) than the eutectic mixture shows excellent quality as well as safety.

### INDUSTRIAL APPLICABILITY

As can be seen from the foregoing, the electrolyte according to the present invention comprises a eutectic mixture in combination with an additive reduced in advance of the eutectic mixture upon the initial charge to form a solid electrolyte interface layer. The electrolyte according to the present invention can solve the problem of electrolyte decomposition occurring when using a eutectic mixture alone as an electrolyte for a battery, and thus can prevent degradation of the quality of a battery.

Although several preferred embodiments of the present invention have been described for illustrative purposes, those skilled in the art will appreciate that various modifications, additions and substitutions are possible, without departing from the scope and spirit of the invention as disclosed in the accompanying claims.

1. A secondary battery comprising a cathode, an anode, a separator and an electrolyte, wherein the electrolyte comprises:
(a) a eutectic mixture; and
(b) a first compound reduced at a higher potential vs. lithium potential (Li/Li⁺) than the lowest limit of the electrochemical window of the eutectic mixture.

2. The secondary battery as claimed in claim 1, wherein the first compound has a reduction potential vs. lithium potential (Li/Li⁺) of 0˜2V.

3. The secondary battery as claimed in claim 1, wherein the first compound is reduced and decomposed in advance of the eutectic mixture upon the initial charge of the battery to form a solid electrolyte interface (SEI) layer.

4. The secondary battery as claimed in claim 1, wherein the first compound is selected from the group consisting of 12-crown-4, 18-crown-6, catechol carbonate, vinylene carbonate, ethylene sulfite, methyl chloroformate, succinimide and methyl cinnamate.

5. The secondary battery as claimed in claim 1, wherein the first compound is used in an amount of 0.01˜10 parts by weight based on 100 parts by weight of the electrolyte.

6. The secondary battery as claimed in claim 1, wherein the eutectic mixture comprises: (a) an amide group-containing compound; and (b) an ionizable lithium salt.

7. The secondary battery as claimed in claim 1, wherein the eutectic mixture is represented by the following Formula 1: 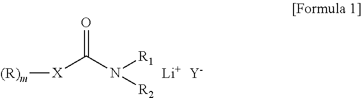
wherein each of R₁, R₂ and R independently represents a hydrogen atom, halogen atom, C1˜C20 alkyl group, alkylamine group, alkenyl group or an aryl group;
X is selected from the group consisting of hydrogen, carbon, silicon, oxygen, nitrogen, phosphor and sulfur, with the proviso that where X is hydrogen, m=0, where X is oxygen or sulfur, m=1, where X is nitrogen or phosphor, m=2, and where X is carbon or silicon, m=3, each R being independent from the others; and
Y is an anion capable of forming a salt with lithium.

8. The secondary battery as claimed in claim 1, wherein the eutectic mixture is represented by the following Formula 2: 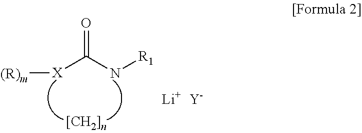
wherein each of R₁ and R independently represents a hydrogen atom, C1˜C20 alkyl group, alkylamine group, alkenyl group, aryl group or an allyl group;
X is selected from the group consisting of hydrogen, carbon, silicon, oxygen, nitrogen, phosphor and sulfur, with the proviso that where X is hydrogen, m=0 and n=0, where X is oxygen or sulfur, m=0, where X is nitrogen or phosphor, m=1, and where X is carbon or silicon, m=2, each R being independent from the others;
n is an integer of 0˜10, with the proviso that where n is equal to or greater than 1, X is selected from carbon, silicon, oxygen, nitrogen, phosphor and sulfur, except hydrogen; and
Y is an anion capable of forming a salt with lithium.

9. The secondary battery as claimed in claim 6, wherein the amide group-containing compound is selected from the group consisting of acetamide, urea, methylurea, caprolactam, valerlactam, trifluoroacetamide, methyl carbamate, formate and formamide.

10. The secondary battery as claimed in claim 6, wherein the anion in the lithium salt is selected from the group consisting of F⁻, Cl⁻, Br⁻, I⁻, NO₃⁻, N(CN)₂⁻, BF₄⁻, ClO₄⁻, PF₆⁻, (CF₃)₂PF₄⁻, (CF₃)₃PF₃⁻, (CF₃)₄PF₂⁻, (CF₃)₅PF⁻, (CF₃)₆P⁻, CF₃SO₃⁻, CF₃CF₂SO₃⁻, (CF₃SO₂)₂N⁻, (FSO₂)₂N⁻, CF₃CF₂(CF₃)₂CO⁻, (CF₃SO₂)₂CH⁻, (SF₅)₃C⁻, (CF₃SO₂)₃C⁻, CF₃ (CF₂)₇SO₃⁻, CF₃CO₂⁻, CH₃CO₂⁻, SCN⁻ and (CF₃CF₂SO₂)₂N⁻.

11. The secondary battery as claimed in claim 1, wherein the electrolyte further comprises a second compound having a higher oxidation potential (vs. Li/Li⁺) than the cathode potential.

12. The secondary battery as claimed in claim 11, wherein the second compound consumes an overcharge current.

13. The secondary battery as claimed in claim 11, wherein the second compound is at least one compound selected from the group consisting of iodine, ferrocene-based compounds, triazolium salts, tricyanobenzene, tetracyanoquinodimethane, benzene-based compounds, pyrocarbonates and cyclohexylbenzene (CHB).

14. The secondary battery as claimed in claim 1, wherein the anode includes an anode active material selected from the group consisting of metal oxides and carbonaceous materials having a reduction potential vs. lithium potential (Li/Li⁺) of lower than 1V.

15. The secondary battery as claimed in claim 1, wherein the lower limit of the electrochemical window of the eutectic mixture ranges from 0.5V to 2V;
the anode has a reduction potential vs. lithium potential (Li/Li⁺) ranging from 0 to the lower limit of the electrochemical window of the eutectic mixture; and
the first compound has a higher potential vs. lithium potential (Li/Li⁺) than the lower limit of the electrochemical window of the eutectic mixture, and is reduced upon the initial charge to form a solid electrolyte interface (SEI) layer.

16. A secondary battery comprising a cathode, an anode, a separator and an electrolyte, wherein the electrolyte comprises a eutectic mixture formed of an amide group-containing compound and an ionizable lithium salt; and the anode is an electrode preliminarily coated with a coating layer partially or totally formed on a surface thereof, the coating layer comprising a first compound reduced at a higher potential vs. lithium potential (Li/Li⁺) than the eutectic mixture or a reduced product thereof.

17. The secondary battery as claimed in claim 16, wherein the anode is any one electrode selected from the group consisting of:
(a) an electrode coated with the first compound on a surface of the electrode active material or a surface of a preliminarily formed electrode;
(b) an electrode using the first compound as a material for forming the electrode; and
(c) an electrode obtained by dipping the electrode into a solution containing the first compound and by carrying out charge/discharge cycles so that a solid electrolyte interface layer comprising the first compound or a reduced product thereof is formed on a surface thereof.

18. The secondary battery as claimed in claim 16, wherein the first compound is selected from the group consisting of 12-crown-4, 18-crown-6, catechol carbonate, vinylene carbonate, ethylene sulfite, methyl chloroformate, succinimide and methyl cinnamate.

19. An electrolyte for a secondary battery comprising:
(a) a eutectic mixture; and
(b) a first compound reduced at a higher potential vs. lithium potential (Li/Li⁺) than the lowest limit of the electrochemical window of the eutectic mixture.

20. The electrolyte for a secondary battery as claimed in claim 19, which is a liquid type electrolyte.

21. The electrolyte for a secondary battery as claimed in claim 19, which is a gel polymer type electrolyte obtained by polymerizing an electrolyte precursor solution comprising:
(i) a eutectic mixture;
(ii) a first compound reduced at a higher potential vs. lithium potential (Li/Li⁺) than the lowest limit of the electrochemical window of the eutectic mixture; and
(iii) monomers capable of forming a gel polymer via polymerization.

22. The electrolyte for a secondary battery as claimed in claim 21, wherein the monomer is at least one vinyl monomer selected from the group consisting of acrylonitrile, methyl methacrylate, methyl acrylate, methacrylonitrile, methyl styrene, vinyl esters, vinyl chloride, vinylidene chloride, acrylamide, tetrafluoroethylene, vinyl acetate, methyl vinyl ketone, ethylene, styrene, para-methoxystyrene and para-cyanostyrene.

23. The electrolyte for a secondary battery as claimed in claim 21, wherein the electrolyte precursor solution further comprises a polymerization initiator.

24. The electrolyte for a secondary battery as claimed in claim 21, which is formed by in-situ polymerization inside a battery.

25. The electrolyte for a secondary battery as claimed in claim 19, which is obtained by impregnating a polymer or gel polymer with (i) the eutectic mixture; and (ii) the first compound reduced at a higher potential vs. lithium potential (Li/Li⁺) than the lowest limit of the electrochemical window of the eutectic mixture.

26. The electrolyte for a secondary battery as claimed in claim 25, wherein the polymer is selected from the group consisting of polymethyl methacrylate, polyvinylidene difluoride, polyvinyl chloride, polyethylene oxide and polyhydroxyethyl methacrylate.
